(19) United States
(12) Patent Application Publication
(10) Pub. No.: US 2004/0131447 A1
(43) Pub. Date: Jul. 8, 2004

(54) Device for backing of book blocks

(76) Inventors: Manfred Albrecht, Lubbecke (DE); Christoph Schmucker, Lubbecke (DE); Karl-Friedrich Schroder, Espelkamp (DE); Dietmar Schwettmann, Rahden (DE)

Correspondence Address: ALIX YALE & RISTAS LLP, 750 MAIN STREET, SUITE 1400, HARTFORD, CT, 06103, US

(21) Appl. No.: 10/738,901

(22) Filed: Dec. 17, 2003

(30) Foreign Application Priority Data
Dec. 21, 2002 (DE) 102 60 476.2

(51) Int. Cl. B42C 13/00

(52) U.S. Cl. 412/14

(57) ABSTRACT

A device for machine backing of rounded book blocks (3), which are clamped in the area close to the spine, by means of a forming block (4) having a concave working face which acts with compressive force on the book block spine (3a), comprises a carriage (5) holding the forming block (4), which carriage (5) is swivellable on arcuate tracks (6a) in a supporting bearing (6) alternately to one side of the book block spine (3a) and the other by means of drive means (18), and comprises means (13-15) for cyclical upward and downward movement of the forming block (4) and a device (16, 17, 19-22) for adjusting the placement height position (H_{A}) of the forming block (4) on the book block spine (3a). A measuring device (36-38, 53) which detects the height position (H_{Rx}) of the book block spine (3a) during continuous operation and a device (30, 31, 33, 43-50, 16, 17, 19-22, 51, 52) which positions the book block (3) to be backed and the forming block (4) to be placed thereon with respect to one another are provided. A constant distance (A) between book block spine (3a) and forming block (4) when placing the forming block (4) is thereby established and consistent backing results are achieved.

### BACKGROUND OF THE INVENTION

The present invention relates to a device for machine backing of rounded book blocks, which are clamped in the area close to the spine, by means of a forming block having a concave working face.

In industrial book production the spines of the book blocks are rounded, backed, glued and provided with additional elements on book production lines before they are joined by full-page pasting to the covers, which are rounded in the spine area. In the stations for rounding and backing the book blocks, the book blocks are first rounded at the spine between driven rounding rollers according to the roller-rounding principle. For the subsequent backing process the book blocks are clamped between backing jaws in the fold area at a defined distance from the end of the rounded portion (hereinafter “round”). By means of reciprocating motions over the full width of the spine, a forming block having a concave working face pushes the sheet or page ends over the backing jaws, backing the spine. The book block receives its mushroom-shaped spine contour, the spine being simultaneously strengthened.

During the backing process the forming block, which is height-adjusted to the rounded book block, is lowered at the centre of the spine and swivels to one side while exerting compressive force on the spine. The forming block is raised from the spine and returns to the centre position, to be lowered on to the spine once more and swivelled under pressure to the other side. Known from DE 199 03 162 A1 is a device for automatically adjusting the height of the forming block during a setting-up process in which a support mounting holding the forming block is lowered on to the spine, the forming block being mounted so as to be freely displaceable vertically on a carriage and to be liftable on making contact with the spine until it abuts the carriage. A proximity initiator switches off the further lowering motion and the forming block is fixed in the carriage by means of controlled clamping devices. The placement height position of the forming block defined in this way remains permanently set during production unless manually readjusted.

A constant distance between the book block spine and the forming block placed thereon is crucial for the backing result. The distance is yielded by the placement height position minus the height of the book block spine and, depending on the shape of the round and the backing, the book block binding in the spine and the properties of the paper, it is less than, equal to or greater than zero. Even small fluctuations of only a few tenths of a millimetre in this distance produce large differences in the results of backing. The fluctuations result from book block spine heights which fluctuate from book block to book block after rounding, for which a plurality of non-constant parameters during production are responsible: cycling speed of the book production line, heating of the book block binding in the spine, elasticity of the book block, glue layer thickness in the preceding gluing of the book block, etc.

If the distance is too large, a large area of the centre of the book block spine is not contacted and deviations from the round which are present in the glue film are not removed. The rounding in the centre portion of the book block spine is lost (false-ellipse effect) and the sheet ends are insufficiently folded at the sides, producing a too-narrow joint and causing the spine width no longer to match the spine lining of the book cover. If the distance is too small, or if the forming block descends too far on to the book block spine, the forming block compresses the middle sheet ends together, resulting in kinked folds. This leads to excessive displacement of material to the sides and the backed book block spine is too wide in relation to the book cover.

### SUMMARY OF THE INVENTION

It is the object of the present invention to provide a device for machine backing of rounded book blocks, which are clamped in the area close to the spine, by means of a forming block having a concave working face, whereby a constant distance between book block spine and forming block throughout production is set on placement of the forming block, in order to achieve consistent quality of the backing.

This is achieved according to the invention by a measuring device which detects the height position of the book block spine during continuous operation, and by a device for positioning the book block to be pressed and/or the forming block placed thereon in such a way that after placement of the forming block a defined distance between the book block spine and the forming block is set.

A first embodiment is characterised by a height measuring device arranged in the rounding station for detecting the height position when the book block is rounded, and by a separately controllable drive device for the rounding rollers which executes the rounding movement until a defined reference height position has been reached. The rounded book blocks are transferred with a constant book block spine height to the backing device, so that a constant distance during the whole of production results from the preset placement height position. Constant backing results are achieved during continuous production even if parameters are changed. This is because the concept of the invention lies in maintaining the book block spine height as accurately as possible and in absorbing fluctuations in rounding in the distance between the end of the round and the backing jaws. The resulting increase or decrease in the folds of the book block by a few tenths of a millimetre is negligible.

A second embodiment is characterised by a height measuring device, arranged in or after the rounding device, for determining the height position attained after rounding of the book block and any resulting deviation from a reference height position of the book block spine, and by a lifting device which moves the rounded book block to a defined reference height position during its transfer to the backing device.

In the third embodiment, adjustment of the forming block placement height position is effected, during the transfer of the book block to the backing device, by controlled actuation of the forming block height adjusting device corresponding to the book block spine height determined after rounding. This embodiment can be advantageously used in book production lines of relatively high output, since the adjustment of the placement height position takes place in the non-productive time of book block transportation and therefore does not reduce output.

The fourth embodiment is characterised by a measuring device arranged in the backing device, which measuring device senses the height position of the book block spine during a downward movement of the forming block effected by the height adjusting device, and by a controlled actuation of the forming block height adjusting device in such a way that the height attained up to the sensing of the height position is fixed. It is advantageous if the forming block is repositioned with respect to the book block spine each time the forming block is placed on the book block spine, i.e., also when the forming block switches from one side of the book block spine to the other, when the forming block is raised to the centre position for the return movement. The measuring device is preferably formed by force-measuring sensors which are recessed in the forming block or the carriage and which signal the contact of the forming block with the book block spine to the height adjusting device. It has proved advantageous to move the forming block to a corrected height position by an additional vertical movement after sensing of the book block spine.

### BRIEF DESCRIPTION OF THE DRAWING

The preferred embodiments of the invention are described in detail below with reference to the drawings, in which each of FIGS. 1 to 4 shows a rounding device and a backing device in adjacent side views at the same level, and in which:

FIGS. 1a and 1b show a first embodiment;

FIGS. 2a and 2b show a second embodiment;

FIGS. 3a and 3b show a third embodiment;

FIGS. 4a and 4b show a fourth embodiment;

FIGS. 5a and 5b show the different height-lines before and after placement of the forming block on the book block spine.

### DESCRIPTION OF THE PREFERRED EMBODIMENT

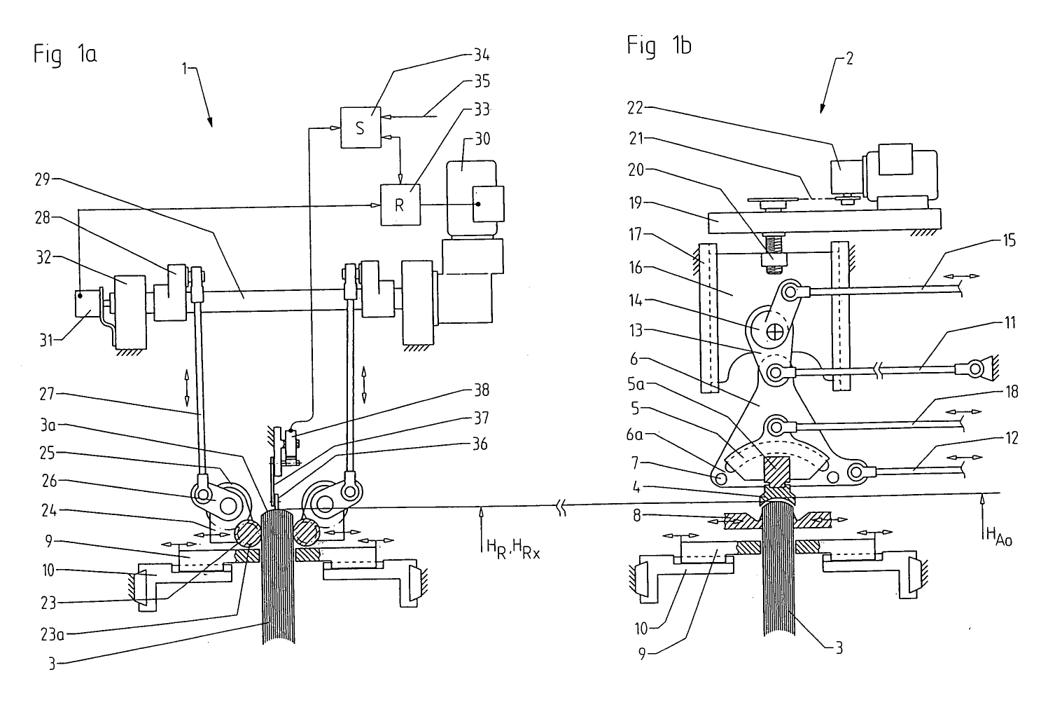

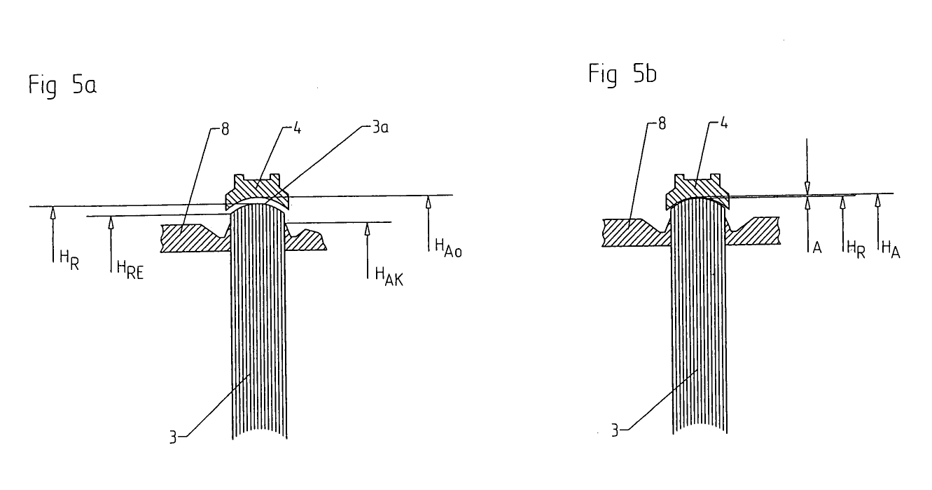

The rounding devices 1 and backing devices 2 for the different embodiments are constructed substantially identically and will first be described in general terms with main reference to FIGS. 1 and 5.

In the rounding device 1 the spines 3a of the book blocks 3 are rounded using the roller-rounding principle. For this purpose the book block 3, resting on its front edge, is laterally clamped by rounding rollers 23 which, through a defined rotary motion under compressive force, roll down both sides of the book block 3, causing a displacement of the sheets whereby the inwardly located sheets of the book block 3 are displaced further. To generate the rotary motion of the rounding rollers 23 the motion of a shaft 29 journalled in bearings 32 above the rounding rollers 23 and rotating in a reciprocating manner is transmitted, via connecting rods 27 coupled to levers 28, to levers 26 which are connected to gear wheels 25 which in turn are operatively connected to toothed elements 23a mounted to the ends of the rounding rollers 23. The rounding rollers 23 and the gear wheels 25 with the levers 26 are in each case journalled in lateral bearings 24 which are movable back and forth in cyclical synchronicity with the clamping of the book block 3.

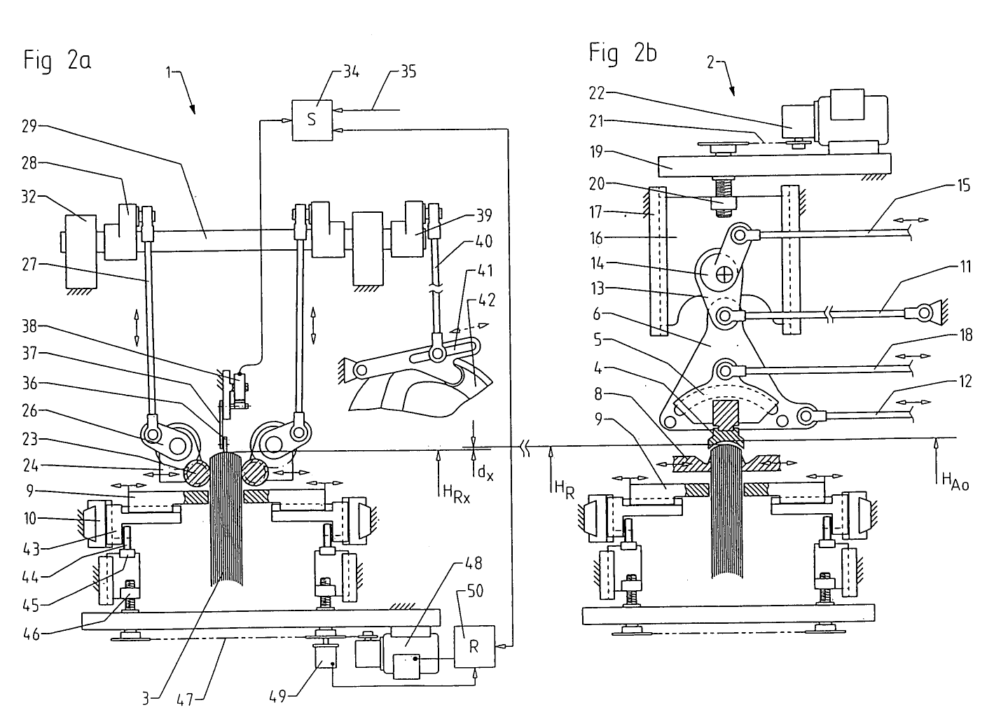

Except in the case of the first embodiment, the reciprocating rotary motion of the shaft 29 is generated by a cam drive drivingly connected to the main drive, the cam disc 42 of which cam drive is shown schematically in FIGS. 2 to 4. A cam lever 41 which is adjustable with respect to the rounding travel is provided and transmits the vertical motion to the shaft 29 via a connecting rod 40 and a lever 39.

The rounded book block 3 is gripped for positive transfer by clamping rails 9 which clamp the book block laterally, and is moved with a transporting carriage 10 to the backing device 2. Backing jaws 8 grip the book block 3 laterally in the fold area at a defined distance from the end of the round and impress the book block. A forming block 4 pushes the sheets of the book block 3 over the backing jaws 8 by means of an oscillating motion and backs the book block spine 3a. To generate the arcuate backing motion the forming block 4, configured as an exchangeable part, is fixed in a seating 5a of a carriage 5 which is provided on both sides with grooves for guidance on freely rotatable rollers 7 arranged in the arcuate track 6a of a supporting bearing 6. The forming block 4 is moved back and forth in known fashion by the main drive via a drive rod 18 articulated to the carriage 5.

During a backing operation the forming block 4, which has been height-adjusted to the rounded book block 3, is lowered at the centre of the spine the 3a and swivels to one side while exerting compressive force on the spine 3a. The forming block 4 is lifted from the spine 3a and returns to the centre position in order to be placed again on the spine 3a and to swivel under pressure to the other side. For cyclical placement and lifting of the forming block 4, the supporting bearing 6 is suspended on an arm 13 which is moved up and down by means of an eccentric shaft 14 which is rotated reciprocally by a drive rod 15. The common pivot of the arm 13 and the supporting bearing 6 is guided centrally over the book block spine 3a by means of a connecting rod 11 pivoted to the fixed frame. A reciprocating drive rod 12, which tilts the supporting bearing 6 laterally to generate a tangential thrusting motion, superimposed on the swivelling motion, in the lateral areas of the book block spine 3a in synchronicity with the swivelling motion of the forming block 4, engages with the lower end of the supporting bearing 6. In FIGS. 1b, 2b and 3b the forming block 4 is shown at height position H_{Ao}, at which it is raised from the book block spine 3a.

The height H_{R} of the book block spine is substantially dependent on the thickness of the book block, the degree of rounding and the distance of the backing jaws 8 from the end of the round. Accordingly, the placement height position H_{A} of the forming block 4 must be adjusted to this book block spine height H_{R}. This occurs during a setting-up process in which the forming block 4 is lowered on to the book block spine 3a until said forming block 4 contacts the book block spine 3a. For this purpose a plate 16 is provided which is guided vertically in guides 17 fixed to the frame and in which the eccentric shaft 14 is journalled, said plate 16 being height-adjustable by means of a spindle adjuster 20 supported with respect to an opposed plate 19. As is known from DE 199 03 162 A1, the setting-up process may be effected by automatic means (not shown in detail). For this purpose the spindle adjuster 20 is driven by a geared motor 22 via a chain drive 21.

In FIGS. 5a and 5b the heights shown in part in the other Figures are represented in detail with reference to a rounded book block 3 before and after the placement of the forming block 4 on the book block spine 3a. The height H_{R} represents the book block spine height which is ideally established after rounding; it may also be referred to as the reference height. In practice, however, for the reasons mentioned in the introduction to the description, fluctuating book block spine heights H_{Rx} are produced. H_{RE} indicates the height of the end of the round. The backing jaws 8 impress the book block 3 laterally at a distance from this end of the round. The upper level of the backing jaws 8 is indicated by H_{AK}. In FIG. 5a the forming block 4 is raised, this dimension being defined by H_{Ao}. In FIG. 5a the forming block 4 has been lowered by a placement motion on to the book block spine 3a, this placement height position being defined by H_{A}. In placement height position H_{A} the forming block 4 can be located minimally above, exactly on or minimally in the book block spine 3a. The distance A, defined as the difference between H_{A} and H_{R}, can therefore be >0, =0 or <0, and is selected according to the desired backing result.

FIGS. 1a and 1b show the first embodiment of the invention. Within the rounding device 1 there is provided a height measuring device which is formed by a roller 36 journalled on a lever 37 as the sensing element and by the associated analogue proximity initiator 38. The height position of the book block spine 3a is detected thereby during rounding. The rounding rollers 23 are driven by a separately controllable drive device, a geared servo motor 30 imparting reciprocating rotary motions to the upper shaft 29.

The associated motor control unit 33 is controlled by a higher-level control unit 34, which evaluates the position messages for the book block spine height coming from the measuring device with those for the shaft 29 coming from a rotation sensor 31. According to the invention the rounding motion is continued until the reference height position H_{R} defined by a teach-in procedure 35 has been reached. The rounded book blocks 3 are transferred to the backing device 2, the book block spine height H_{R} being kept constant, so that, by means of the preset placement height position H_{A} of the forming block 4, a constant distance A is maintained throughout production.

The second embodiment is illustrated in FIGS. 2a and 2b. The height measuring device (36-38) known from FIG. 1a detects the book block spine height H_{Rx} attained during rounding of the book block 3. The control unit 34 calculates the resulting deviation dₓ from the reference book block spine height H_{R} predefined by means of the teach-in 35 and converts it into corresponding control commands for an adjusting motor 48 with associated motor control unit 50. A lifting device which moves the rounded book block 3 to a height-displaced position during its transfer is activated by the adjusting motor 48, so that the reference book block spine height H_{R} is established in the backing device 2. The lifting device is formed by an intermediate carrier 43 which is vertically movable by means of a transporting carriage 10 and is supported on a rail 45 by rollers 44, and a spindle adjuster 46 which adjusts the rail 45 during the transfer of the book block 3. The spindle adjuster 46 is drivingly connected to the adjusting motor 48 via a chain drive 47 and is monitored by a rotation sensor 49. As in the case of the first embodiment, the rounded book blocks 3 are transferred to the backing device 2, the book block spine height H_{R} being maintained constant.

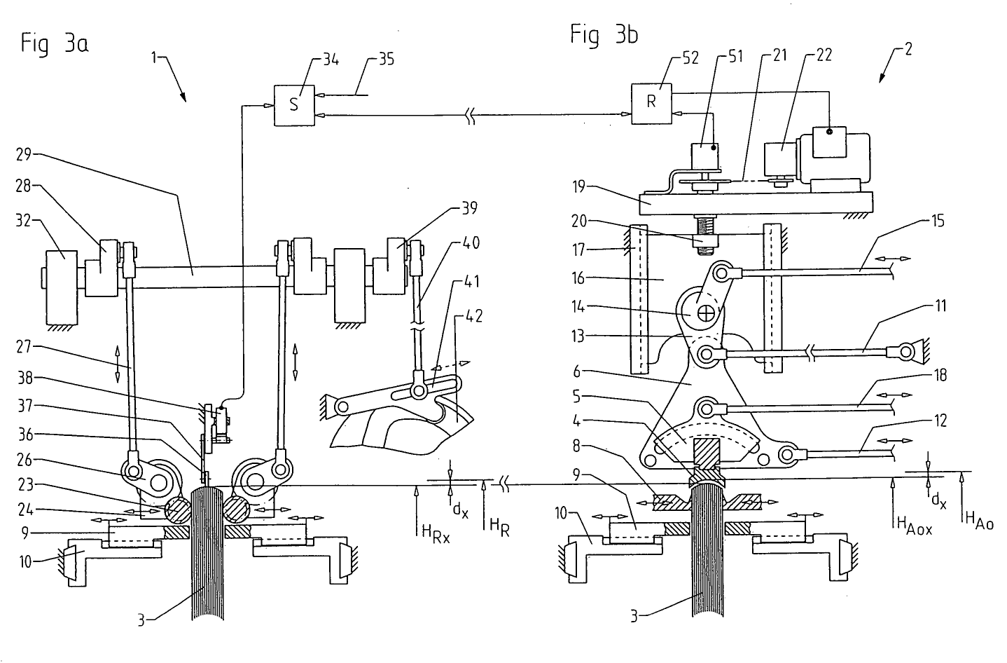

FIGS. 3a and 3b show the third embodiment. The book block spine height H_{Rx} reached after rounding and the resulting deviation dx are detected by the control unit 34 in a manner comparable to that of the second embodiment.

However, the rounded book block 3 is transferred to the backing device 2 without height adjustment. Instead, the time during the transfer of the book block is used to adjust the placement height position H_{A} of the forming block 4. The latter is moved to a height position H_{Aox} corresponding to the respective book block spine height H_{Rx}, this being the raised position of the forming block 4 before placement. The cyclical placement is effected by the controlled movement of the eccentric shaft 14, by which the desired distance A between forming block 4 and book block spine 3a is set. The adjustment of the placement height position H_{A} of the forming block 4 is effected by means of the above-described height adjusting device, a rotation sensor 51 and a motor control unit 52 forming the feedback control system with the control unit 34.

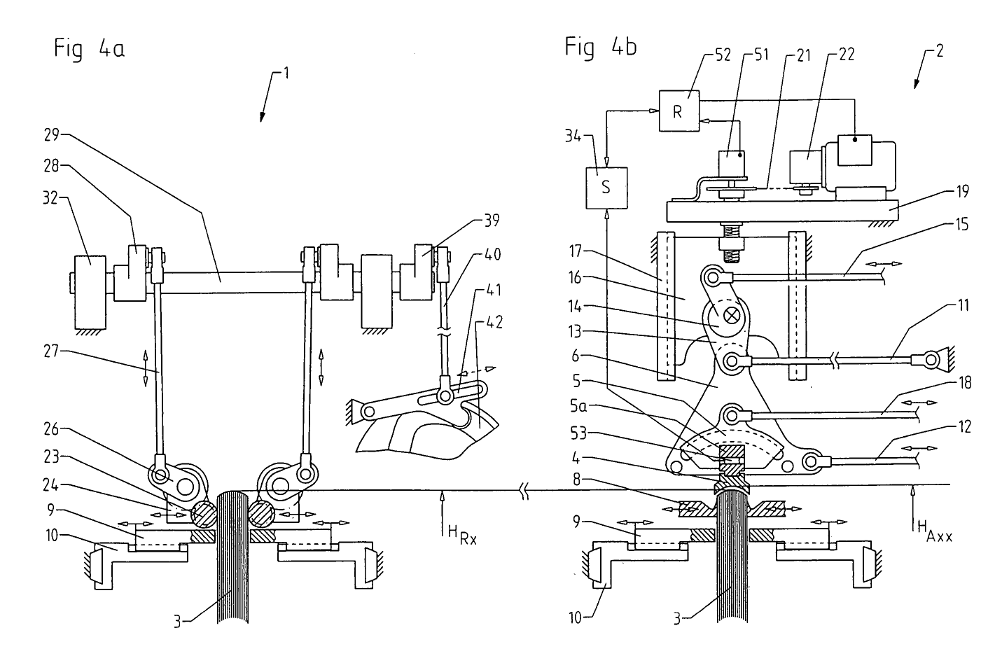

The fourth embodiment, illustrated in FIGS. 4a and 4b, dispenses with the above-described measuring device (36-38). The spine 3a of the rounded book block 3 transferred to the backing device 2 is sensed by controlled actuation of the height adjusting device of the forming block 4, in that the forming block 4, which has been lowered in connection with the backing movement, is lowered, starting from a higher initial position H_{Axx}, on to the book block spine, and the contact of the forming block 4 with the book block spine 3a is effected through a signal from a load cell 53 recessed in the seating 5a. A teach-in 35 of a reference book block spine height H_{R} is not required. The forming block 4 detects the respective book block spine height H_{RX} practically automatically and adjusts itself thereto. In a further refinement, an adjusted height position may be adopted by means of an additional vertical movement. Positioning can take place each time the forming block 4 is placed, i.e. also when it switches from one side of the book block spine to the other. The book block spine height changed by the first part of the backing process can thereby be taken into account.

1. In a machine for backing book blocks having a back region including a spine and laterally adjacent areas running along the spine, said machine including means for clamping the book blocks and conveying the clamped book blocks with rounded spines to a forming block having a concave working face which after positioning at a placement height position on the spine acts with compressive force on the spine, a carriage holding the forming block, which carriage is driven on arcuate tracks alternately to one lateral side of the rounded spine and the other lateral side of the rounded spine, and means for cyclical upward and downward movement of the forming block to and from said placement height corresponding to cyclical positioning of each successively conveyed book block below the forming block, the improvement comprising: measuring means for detecting the height position (H_{Rx}) of the book block spine during continuous operation of the machine and means responsive to the measuring means, for positioning the book block to be pressed and/or the forming block to be placed thereon at a placement height position such that after placement a defined distance (A) is established for the book block between the book block spine and the forming block.

2. Machine according to claim 1, wherein the measuring means is arranged in a spine rounding device located upstream of the forming block, for detecting the height position during rounding of the book block; and the means for positioning includes a separately controllable drive for rounding rollers of the rounding device which act on the laterally adjacent areas running along the spine and execute the rounding movement until a defined reference height (H_{R}) position of the spine has been reached.

3. Machine according to claim 1, wherein the measuring means is arranged in or after a spine rounding device located upstream of the forming block, for detecting the spine height position (H_{Rx}) reached after rounding of the book block and determining a resulting deviation (dₓ) from a reference height position (H_{R}) of the book block spine, and the means for positioning includes a lifting device downstream of the measuring means, which moves the rounded book block to the defined reference height position during its conveyance to the forming block.

4. Machine according to claim 1, wherein the measuring means is arranged in or after a spine rounding device located upstream of the forming block, for detecting the height position (H_{Rx}) reached after rounding of the book block and determining a resulting deviation (dₓ) from a reference height position (H_{R}) of the book block spine, and the means for positioning includes a controller for actuation of a height adjusting device of the forming block, carried out during conveyance of the book block to the forming block, for adjusting the placement height position (H_{A}, H_{Ax}) of the forming block according to the determined deviation.

5. Machine according to claim 1, wherein the measuring means senses the height position (H_{Rx}) of the book block spine during a downward movement of the forming block and the means for positioning includes a controller for actuation of a height adjusting device of the forming block such that the height reached up to the sensing of the height position (H_{Rx}) is fixed.

6. Machine according to claim 5, wherein the forming block is repositioned with respect to the book block spine each time it is placed on the book block spine.

7. Machine according to claim 5, wherein the measuring means includes force measuring sensors and detection of the height position (H_{Rx}) is effected by lowering the forming block on to the book block spine until contact is made and a signal is generated by the force sensors.

8. Machine according to claim 5, wherein after sensing of the book block spine the height adjusting device moves the forming block to a corrected height position by means of an additional vertical movement.

9. Machine according claim 1, wherein the measuring means is formed by a sensing element mounted on a lever and by an associated analogue proximity initiator.

10. Machine according to claim 1, wherein the defined distance (A) is equal to zero, a few tenths of a millimetre greater than zero or a few tenths of a millimetre less than zero.

11. Machine according to claim 1, wherein measuring means detects the height position (H_{Rx}) of the book block spine of each book block to be backed and the means for positioning positions the book block and the forming block with respect to one another.

12. A machine for processing book blocks having a back region including a spine and laterally adjacent areas running along the spine, comprising: (a) means for rounding book block spines; (b) means for conveying book blocks with rounded spines to a spine backing location; (c) a forming block at the spine forming location, having a concave working face which acts with compressive force on the book block spine; (d) a carriage holding the forming block, which carriage is pivotally mounted whereby the forming block alternately presses one lateral side of the book block spine and the other lateral side of the book back spine; (e) means for cyclical upward and downward movement of the forming block with reference to a placement height position of the forming block; (f) means for adjusting the placement height position of the forming block; (g) a measuring device which detects the height position (H_{Rx}) of the book block spine during operation of the machine at or upstream of the spine backing location; and (h) a device responsive to the measuring device, for positioning the book block to be pressed and/or the forming block to be placed thereon in such a way that after placement a defined distance (A) is established between the book block spine and the forming block.

13. Machine according to claim 12, wherein the measuring device is located above rounding rollers at the means for rounding spines, for detecting the height position during rounding of the book block, and the device for positioning includes a separately controllable drive for the rounding rollers which executes the rounding movement until a defined reference height position has been reached.

14. Machine according to claim 12, wherein the measuring device is located in or after the means for rounding, for detecting the height position reached after rounding of the book block and determining a resulting deviation from a reference height position of the book block spine, and the means for positioning includes a lifting device which moves the rounded book block to the defined reference height position during conveyance to the means for backing.

15. Machine according to claim 12, wherein the measuring device is arranged in or after the means for rounding, for detecting the height position reached after rounding of the book block and determining a resulting deviation from a reference height position of the book block spine, and the device for positioning includes a controller for actuating the means for adjusting the placement height position, during conveyance of the book block to the means for rounding, for adjusting the placement height position of the forming block according to the determined deviation.

16. Machine according to claim 12, wherein the measuring device is located at the forming block, for sensing the height position of the book block spine during a downward movement of the forming block, and the device for positioning is a controller for actuation of the means for adjusting the placement height position of the forming block such that the height reached up to the sensing of the height position is fixed.

17. Device according to claim 16, wherein the forming block is repositioned with respect to the book block spine each time it is placed on the book block spine.

18. Machine according to claim 17, wherein the measuring device is formed by force measuring sensors, and detection of the height position is effected by lowering the forming block on to the book block spine until contact is made and the sensors generate a signal.

19. Machine according to claim 16, wherein after sensing of the book block spine the height adjusting device moves the forming block to a corrected height position by means of an additional vertical movement.

20. Machine according to claim 12, wherein the measuring device is formed by a sensing element mounted on a lever and by an associated analogue proximity initiator.

21. Machine according to claim 12, wherein the defined distance is selected from the values of zero, up to three tenths of a millimetre greater than zero, or up to three tenths of a millimetre less than zero.

22. Machine according to claim 12, wherein the measuring device detects the height position of the book block spine of each book block to be backed and the means for positioning positions each of the book block and the forming block with respect to one another.
